(19) United States
(12) Patent Application Publication
(10) Pub. No.: US 2026/0203178 A1
(43) Pub. Date: Jul. 16, 2026

(54) MICROCONTROLLER WITH ERROR INJECTION CIRCUITRY AND METHOD OF USING SAME

(71) Applicant: Microchip Technology Incorporated, Chandler, AZ (US)

(72) Inventors: Kjetil Kirkholt, LENSVIK (NO); Asgeir Schanke, Trondelag (NO); Amund Aune, Heimdal (NO); Henrik Moe Arnesen, Trondheim (NO)

(21) Appl. No.: 19/358,258

(22) Filed: Oct. 14, 2025

Related U.S. Application Data
(60) Provisional application No. 63/744,640, filed on Jan. 13, 2025.

(51) Int. Cl. G06F 11/22; G06F 11/14; G06F 11/277

(52) U.S. Cl. CPC G06F 11/2236; G06F 11/1441; G06F 11/277

(57) ABSTRACT

A microcontroller having error injection circuitry is provided. The microcontroller may include one or more operational components, and an error injection circuity operatively coupled to the one or more operational components. The error injection circuitry may autonomously inject one or more errors into the one or more operational components, and guard one or more error channels associated with the one or more operational components during the injection of the one or more errors.

### CROSS-REFERENCE TO RELATED APPLICATION

The present application claims priority to U.S. Provisional Patent Application No. 63/744,640 filed on Jan. 13, 2025, which is incorporated herein by reference in its entirety.

### TECHNICAL FIELD

The present disclosure relates generally to microcontrollers, more specifically to a microcontroller with error injection circuitry.

### SUMMARY

According to an aspect of one or more examples, there is provided a microcontroller. The microcontroller may include one or more operational components and an error injection circuitry operatively coupled to the one or more operational components. The error injection circuitry may autonomously inject one or more errors into the one or more operational components and guard one or more error channels associated with the one or more operational components during the injection of the one or more errors.

The error injection circuitry may arm the one or more error channels prior to the injection to prepare the one or more operational components to receive the one or more errors and disarm the one or more error channels after the injection to prevent one or more unintended errors from affecting the one or more operational components. The microcontroller may include an error controller operatively coupled to the error injection circuitry and the one or more error channels. The error controller may set the microcontroller to a safe state by transmitting an input/output (IO) float signal to trigger an electrically floating state of one or more IO pins of the microcontroller and sending a reset request to a reset controller to initiate a reset of the one or more operational components.

The error injection circuitry may guard the one or more channels by monitoring the one or more error channels of the one or more operational components where the one or more errors are injected, comparing a response on the one or more error channels associated with the one or more operational components with an expected response that the one or more errors are intended to cause and identifying one or more actual errors based on a variation between the response and the expected response.

The error injection circuitry may transmit a reset request to a reset controller to initiate a reset of the one or more operational components in response to the identification of the one or more actual errors and send an actual error detected signal to the error controller. The error controller may set the microcontroller to the safe state. The error controller may receive a signal through the one or more error channels of the one or more operational components regarding the one or more errors injected by the error injection circuitry and set the microcontroller to the safe state based on the signal. The error controller may obtain the actual error detected signal from the error injection circuitry in response to the variation identified between the response and the expected response by the error injection circuitry, and set the microcontroller to the safe state based on the actual error detected signal.

The microcontroller may include a fault detection time interval (FDTI) timer configured to trigger the autonomous injection of the one or more errors in response to a time interval elapsing. The error injection circuitry may be configured to receive one or more external triggers and initiate the autonomous injection of the one or more errors in response to the one or more external triggers.

According to an aspect of one or more examples, there is provided a method. The method may include autonomously injecting one or more errors into one or more operational components of a microcontroller by an error injection circuitry and guarding one or more error channels associated with the one or more operational components during the injection of the one or more errors by the error injection circuitry.

The method may include arming the one or more error channels prior to the injection to prepare the one or more operational components for receiving the one or more errors and disarming the one or more error channels after the injection to prevent one or more unintended errors from affecting the one or more operational components. The method may include setting the microcontroller to a safe state by an error controller. The setting operation may include performing one or more of transmitting an input/output (IO) float signal to trigger an electrically floating state of one or more IO pins of the microcontroller, and sending a reset request to a reset controller to initiate a reset of the one or more operational components.

The guarding operation may include monitoring the one or more error channels associated with the one or more operational components during the injection of the one or more errors, comparing a response on the one or more error channels associated with the one or more operational components with an expected response that the one or more errors are intended to cause and identifying one or more actual errors based on a variation between the response and the expected response.

The method may include transmitting, by the error injection circuitry, a reset request to a reset controller to initiate a reset of the one or more operational components in response to the identification of the one or more actual errors and sending, by the error injection circuitry, an actual error detected signal to an error controller. The error controller may set the microcontroller to the safe state. The method may include receiving, by the error controller, a signal through the one or more error channels of the one or more operational components regarding the one or more errors injected by the error injection circuitry and setting, by the error controller, the microcontroller to the safe state based on the signal. The method may include obtaining, by the error controller, an actual error detected signal from the error injection circuitry in response to a variation identified between a response and an expected response by the error injection circuitry, and setting, by the error controller, the microcontroller to the safe state based on the actual error detected signal.

According to one or more examples, the autonomous injecting of the one or more errors may be triggered by a fault detection time interval (FDTI) timer in response to a time interval elapsing. According to one or more examples, the autonomous injecting of the one or more errors may be triggered by one or more external triggers.

According to an aspect of one or more examples, there is provided an apparatus that may include an error injection circuitry and a fault detection time interval (FDTI) timer. The error injection circuitry may be configured to inject one or more errors into one or more operational components of a microcontroller in response to a time interval of the FDTI timer elapsing, and guard one or more error channels associated with the one or more operational components during the injection of the one or more errors.

The error injection circuitry may be configured to arm the one or more error channels prior to the injection to prepare the one or more operational components to receive the one or more errors, and disarm the one or more error channels after the injection to prevent one or more unintended errors from affecting the one or more operational components. The error injection circuitry may be configured to guard the one more error channels by monitoring the one or more error channels of the one or more operational components where the one or more errors are injected, comparing a response on the one or more error channels associated with the one or more operational components with an expected response that the one or more errors are intended to cause, and identifying one or more actual errors based on a variation between the response and the expected response.

The error injection circuitry, in response to the identification of the one more actual errors, may be configured to initiate a reset of the one or more operational components, and send an actual error detected signal to an error controller to set the microcontroller to a safe state.

### BRIEF DESCRIPTION OF DRAWINGS

FIG. 1 shows a block diagram illustrating a microcontroller according to one or more examples.

FIG. 2 shows a block diagram illustrating a method according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Microcontrollers are used in electronic devices to perform tasks in safety-focused applications like automotive, industrial controls, medical devices, aerospace systems and defense systems. Diagnostic mechanisms in the microcontrollers may be tested by injecting errors into operational components to verify whether the microcontrollers can detect and respond to faults reliably, thereby maintaining functional safety. The injection of the errors is managed through software, which may introduce significant overhead. Injecting multiple software-based errors may consume CPU time, increase code complexity, and lead to higher memory usage, which in turn impacts efficiency of the microcontroller. Moreover, handling results of the software-based error injection needs additional CPU resources, which increases complexity and timing demands. Therefore, there is a need for an improved microcontroller with hardware-based error injection circuitry.

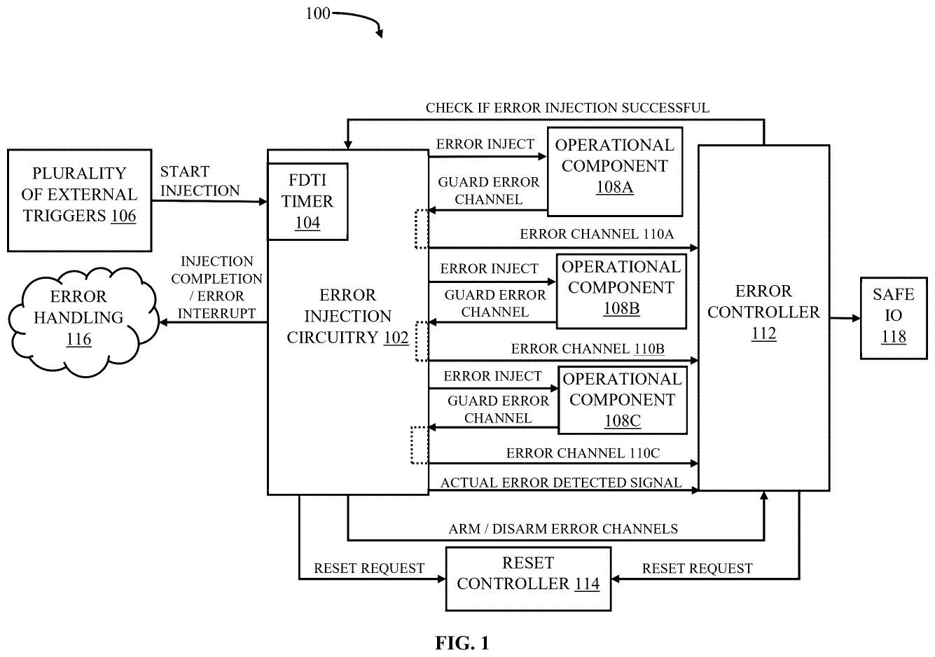

FIG. 1 shows a block diagram illustrating a microcontroller 100 according to one or more examples. The microcontroller 100 may include an error injection circuitry 102 configured to receive a plurality of external triggers 106, one or more operational components 108A-108C, one or more error channels 110A-110C, an error controller 112 and a reset controller 114. The error injection circuitry 102 may include a fault detection time interval (FDTI) timer 104.

The error injection circuitry 102 may be operatively coupled to the operational components 108A, 108B, and 108C through the error channels 110A, 110B, and 110C, respectively. In one or more examples, the operational component 108A may be a central processing circuitry, and the error channel 110A may be associated with the central processing circuitry. The operational component 108B may be a Non-Volatile Memory (NVM) and the error channel 110B may be associated with the NVM. The operational component 108C may be a Random Access Memory (RAM) and the error channel 110C may be associated the RAM. In one or more examples, each of the one or more error channels may be associated with a corresponding operational component such that one or more errors are injected by the error injection circuitry 102. The error injection circuitry 102 may inject the one or more errors into the one or more operational components to test hardware-based diagnostic mechanisms and monitor the error channels for any deviations from expected behavior during injection. The error injection circuitry 102 may handle the injection of the one or more errors independently, without relying on intervention of a central processing circuitry (not shown), thereby reducing software overhead and load on the central processing circuitry.

In one or more examples, the central processing circuitry may be notified when the injection of the one or more errors by the error injection circuitry 102 encounters a failure or does not perform as expected. The error injection circuitry 102 may arm the error channels prior to initiating the injection of the one or more errors, preparing the operational components to receive the one or more errors. After completion of the injection of the one or more errors, the error injection circuitry 102 may disarm the error channels to prevent one or more unintended errors from affecting the one or more operational components.

The FDTI timer 104 may be integrated into the error injection circuitry 102 to autonomously control timing of the one or more errors to be injected into the operational components 108A, 108B and 108C through the error channels 110A, 110B and 110C. The FDTI timer 104 may be set to a predetermined time interval. In one or more examples, the FDTI timer 104, when the predetermined time interval elapses, may activate the error injection circuitry 102 to inject the one or more errors into the operational components 108A-108C. After each activation, the FDTI timer 104 may reset to the predetermined time interval, preparing for next cycle of the injection of the one or more errors.

The error injection circuitry 102 may be activated by at least one of a plurality of activation methods. In one or more examples, the plurality of activation methods may include the FDTI timer 104 and the plurality of external triggers 106. The plurality of external triggers 106 may include an external timer, an event system, error injection software, and an external pin. Once activated by at least one of the plurality of activation methods, the error injection circuitry 102 may initiate the injection of one or more errors into the operational components 108A, 108B, and 108C through the corresponding error channels 110A, 110B, and 110C. During the injection of the one or more errors, the error injection circuitry 102 may guard the one or more channels associated with the one or more operational components.

In order to guard the one or more channels, the error injection circuitry 102 may monitor each of the one or more error channels 110A, 110B, and 110C associated with the one or more operational components 108A, 108B, and 108C where the one or more errors are injected. The error injection circuitry 102 may then compare a response on the one or more error channels 110A, 110B, and 110C associated with the one or more operational components 108A, 108B, and 108C with an expected response that the one or more errors are intended to cause, using a comparator (not shown). The comparison of the response with the expected response performed by the comparator may facilitate the error injection circuitry 102 to identify one or more actual errors.

In an event where there is a variation between the response and the expected response, the error injection circuitry 102 may identify that one or more actual errors occurred during the injection of the one or more errors. Alternatively, the error injection circuitry 102 may determine that the one or more operational components 108A, 108B, and 108C are functioning within acceptable parameters if the response matches the expected response. In one or more examples, the error injection circuitry 102 may initiate a corrective action in response to the identification of the one or more actual errors. The corrective action may include transmitting a reset request to the reset controller 114 to initiate a reset of the one or more operational components 108A-108C. Alternatively, the corrective action may include sending an actual error detected signal to the error controller 112, where the error controller 112 may set the microcontroller 100 to a safe state.

In one or more examples, the error controller 112 may be operatively coupled to the error injection circuitry 102 and the error channels 110A, 110B, and 110C. Upon receiving the actual error detected signal from the error injection circuitry 102, the error controller 112 may set the microcontroller 100 to the safe state by transmitting an input/output (IO) float signal, which triggers an electrically floating state of one or more IO pins 118 of the microcontroller 100, isolating the operational components to prevent further processing or unintended behavior. Additionally, the error controller 112 may send the reset request to the reset controller 114, prompting the reset controller 114 to reset the operational components 108A, 108B, and 108C in order to set the microcontroller 100 to the safe state.

In one or more examples, the error controller 112 may receive a signal through the error channels 110A, 110B, and 110C that provides feedback on the one or more errors injected by the error injection circuitry 102 for the operational components 108A, 108B, and 108C. Based on the feedback signal from the error channels 110A, 110B, and 110C associated with the operational components 108A, 108B, and 108C, the error controller 112 may set the microcontroller 100 to the safe state. The error injection circuitry 102 may then perform a verification operation by checking if the error injection was successful, based on the error controller 112 setting the microcontroller 100 to the safe state.

The microcontroller may include an error handling application 116. Once the error injection operation is complete, the error injection circuitry 102 may send an injection completion or error interrupt signal to the error handling application 116. The injection completion signal may indicate that the error injection operation concluded successfully, while the error interrupt signal may notify the error handling application 116 of the one or more actual errors detected during the injection operation.

The error injection circuitry 102 may manage the arming and disarming of the error channels 110A, 110B, and 110C prior to and after the injection of errors, respectively, to prepare and protect the operational components 108A, 108B, and 108C from unintended interference. In one or more examples, the error injection circuitry 102 may send the reset request directly to the reset controller 114, as shown in FIG. 1, to initiate the reset of the operational components if an actual error is detected. Upon receiving the reset request, the reset controller 114 may reset the operational components, allowing the microcontroller 100 to re-establish normal operation.

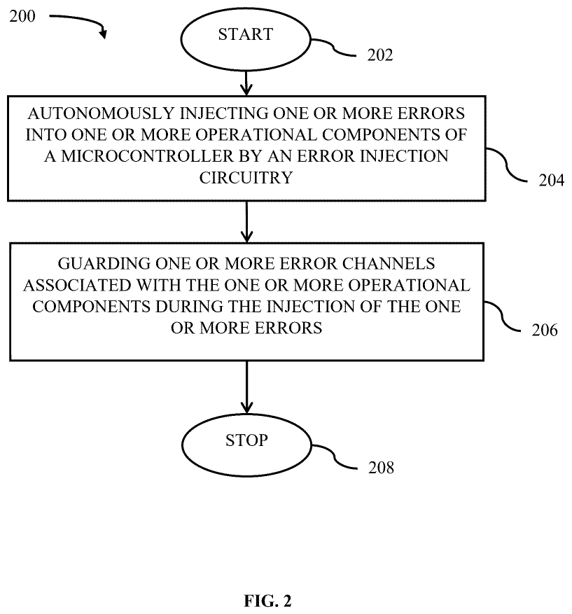

FIG. 2 shows a flowchart 200 illustrating a method according to one or more examples. It may be noted that in order to explain the method operations of the flowchart 200, references will be made to the elements explained in FIG. 1.

The flowchart 200 starts at operation 202. At operation 204, the method may include autonomously injecting the one or more errors into the one or more operational components of the microcontroller 100 by the error injection circuitry 102. At operation 206, the method may include guarding the one or more error channels associated with the one or more operational components during the injection of the one or more errors.

The flowchart 200 terminates at operation 208. It may be noted that the flowchart 200 is explained to have above stated process operations; however, those skilled in the art would appreciate that the flowchart 200 may have more/less number of process operations which may enable all the above stated embodiments of the present disclosure.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A microcontroller comprising:
one or more operational components; and
an error injection circuity operatively coupled to the one or more operational components, wherein the error injection circuitry is to:
autonomously inject one or more errors into the one or more operational components; and
guard one or more error channels associated with the one or more operational components during the injection of the one or more errors.

2. The microcontroller of claim 1, wherein the error injection circuitry is to:
arm the one or more error channels prior to the injection to prepare the one or more operational components to receive the one or more errors; and
disarm the one or more error channels after the injection to prevent one or more unintended errors from affecting the one or more operational components.

3. The microcontroller of claim 1, further comprising an error controller operatively coupled to the error injection circuitry and the one or more error channels, wherein the error controller is to set the microcontroller to a safe state by performing one or more of:
transmitting an input/output (IO) float signal to trigger an electrically floating state of one or more IO pins of the microcontroller; and
sending a reset request to a reset controller to initiate a reset of the one or more operational components.

4. The microcontroller of claim 1, wherein the error injection circuitry is to guard the one or more error channels by:
monitoring the one or more error channels of the one or more operational components where the one or more errors are injected;
comparing a response on the one or more error channels associated with the one or more operational components with an expected response that the one or more errors are intended to cause; and
identifying one or more actual errors based on a variation between the response and the expected response.

5. The microcontroller of claim 4, wherein the error injection circuitry, in response to the identification of the one or more actual errors, is to:
transmit a reset request to a reset controller to initiate a reset of the one or more operational components; and
send an actual error detected signal to an error controller, wherein the error controller is to set the microcontroller to a safe state.

6. The microcontroller of claim 3, wherein the error controller is to:
receive a signal through the one or more error channels of the one or more operational components regarding the one or more errors injected by the error injection circuitry, and based on the signal, set the microcontroller to the safe state; and
obtain an actual error detected signal from the error injection circuitry in response to a variation identified between a response and an expected response by the error injection circuitry, and based on the actual error detected signal, set the microcontroller to the safe state.

7. The microcontroller of claim 1, comprising a fault detection time interval (FDTI) timer configured to trigger the autonomous injection of the one or more errors in response to a time interval elapsing.

8. The microcontroller of claim 7, wherein the error injection circuitry is configured to receive one or more external triggers and initiate the autonomous injection of the one or more errors in response to the one or more external triggers.

9. A method comprising:
autonomously injecting, by an error injection circuitry, one or more errors into one or more operational components of a microcontroller; and
guarding, by the error injection circuitry, one or more error channels associated with the one or more operational components during the injection of the one or more errors.

10. The method of claim 9, further comprising:
arming, by the error injection circuitry, the one or more error channels prior to the injection to prepare the one or more operational components for receiving the one or more errors; and
disarming, by the error injection circuitry, the one or more error channels after the injection to prevent one or more unintended errors from affecting the one or more operational components.

11. The method of claim 9, further comprising setting, by an error controller, the microcontroller to a safe state by performing one or more of:
transmitting an input/output (IO) float signal to trigger an electrically floating state of one or more IO pins of the microcontroller; and
sending a reset request to a reset controller to initiate a reset of the one or more operational components.

12. The method of claim 9, wherein the guarding operation comprises:
monitoring the one or more error channels associated with the one or more operational components during the injection of the one or more errors;
comparing a response on the one or more error channels associated with the one or more operational components with an expected response that the one or more errors are intended to cause; and
identifying one or more actual errors based on a variation between the response and the expected response.

13. The method of claim 12, further comprising:
transmitting, by the error injection circuitry, a reset request to a reset controller to initiate a reset of the one or more operational components in response to the identification of the one or more actual errors; and
sending, by the error injection circuitry, an actual error detected signal to an error controller, wherein the error controller sets the microcontroller to a safe state.

14. The method of claim 11, further comprising:
receiving, by the error controller, a signal through the one or more error channels of the one or more operational components regarding the one or more errors injected by the error injection circuitry, and based on the signal, setting the microcontroller to the safe state; and
obtaining, by the error controller, an actual error detected signal from the error injection circuitry in response to a variation identified between a response and an expected response by the error injection circuitry, and based on the actual error detected signal, setting the microcontroller to the safe state.

15. The method of claim 9, wherein the autonomous injecting of the one or more errors is triggered by a fault detection time interval (FDTI) timer in response to a time interval elapsing.

16. The method of claim 9, wherein the autonomous injecting of the one or more errors is triggered by one or more external triggers.

17. An apparatus comprising:
an error injection circuitry; and
a fault detection time interval (FDTI) timer;
wherein the error injection circuitry is configured to:
inject one or more errors into one or more operational components of a microcontroller in response to a time interval of the FDTI timer elapsing; and
guard one or more error channels associated with the one or more operational components during the injection of the one or more errors.

18. The apparatus of claim 17, wherein the error injection circuitry is configured to:
arm the one or more error channels prior to the injection to prepare the one or more operational components to receive the one or more errors; and
disarm the one or more error channels after the injection to prevent one or more unintended errors from affecting the one or more operational components.

19. The apparatus of claim 17, wherein the error injection circuitry is configured to guard the one or more error channels by:
monitoring the one or more error channels of the one or more operational components where the one or more errors are injected;
comparing a response on the one or more error channels associated with the one or more operational components with an expected response that the one or more errors are intended to cause; and
identifying one or more actual errors based on a variation between the response and the expected response.

20. The apparatus of claim 19, wherein the error injection circuitry, in response to the identification of the one or more actual errors, is configured to perform at least one of:
initiate a reset of the one or more operational components; and
send an actual error detected signal to an error controller to set the microcontroller to a safe state.
